(19) United States
(12) Patent Application Publication
(10) Pub. No.: US 2012/0179478 A1
(43) Pub. Date: Jul. 12, 2012

(54) Devices, Systems, and Methods for the Real-Time and Individualized Prediction of Health and Economic Outcomes

(75) Inventor: Allan Ross, San Diego, CA (US)

(73) Assignee: 1eMERGE, Inc., San Diego, CA (US)

(21) Appl. No.: 12/986,027

(22) Filed: Jan. 6, 2011

(51) Int. Cl. G06Q 50/00

(52) U.S. Cl. 705/2

(57) ABSTRACT

Provided herein are computer-implemented platforms, systems, products, devices, modules and methods for the real-time, individualized, and probabilistic-based prediction of a health or economic outcome of a patient or healthcare provider therapy using emerging health or economic data. Also provided herein is the transformation of emerging health or economic data to predict a health or economic outcome of a patient.

### BACKGROUND OF THE INVENTION

Medical-related information, including the economics of potential treatment plans, comes from many different sources. Common sources include peer reviewed medical journals, which typically publish articles 6 to 12 months after completion of a 1 to 3 year study. Medical-related information may be used by healthcare professionals for the prescription and analysis of tests and/or for the diagnosis and treatment of medical events. Medical-related information may also be used to analyze medical risks for quality of care related patient outcomes and economic related outcomes, such as the cost and expected length of stay in a hospital for a particular patient, with a specific condition, treated by an identified healthcare provider. Patients, providers, and payers for medical services alike have an interest in information pertaining to quality of care related patient outcomes and economic related outcomes.

An effective healthcare system is designed to provide good health to the target population for a fair financial contribution. Managing an effective healthcare system requires an accurate assessment of health risks enabling risk-takers (including patients, providers, and payers) to make informed decisions on subsequent courses of action, costs of treatment, lengths of inpatient stays, and the like. When making immediate decisions about patient care, individual patients, providers, and payers are faced with completely processing, weighting, and applying large volumes of medical-related information.

### SUMMARY OF THE INVENTION

Existing medical assessment environments are often based on unscientific, incorrect, or outdated and irrelevant information and often lack the ability to recognize irrelevant data resulting in a slow system that cannot deliver an efficient and quick assessment. Prior attempts to predict health outcomes are based on outdated therapies applied and the analysis of statistics retrospectively in large group outcome studies done in the remote past. Assessments made using such environments are often based on historical data that often do not account for the specific individual's conditions. For example, healthcare professionals often rely solely on information from peer reviewed medical journals for purposes of rendering an opinion.

Technology offers healthcare systems new opportunities to improve the effectiveness and efficiency of the provision of healthcare. For example, computers allow healthcare providers to process, store, and retrieve an individual patient's medical information quickly and efficiently. Electronic medical records (EMRs), in particular, are computerized medical records created in an organization that delivers care, such as a hospital. EMRs tend to be a part of a local stand-alone health information system that allows storage, retrieval, and modification of records. However, existing methodologies, including EMRs, are inadequate to accurately predict the likelihood of a positive outcome of a particular treatment procedure because decisions relying on EMRs are entirely retrospective. That is, these retrospective analytical models are deficient because they fail to capture emerging patient data that often times has more relevance to the likelihood of a successful outcome and cost of a medical procedure than the retrospective history.

An electronic, computer-implemented solution is needed to electronically access, process, weight, transform, and apply the vast volumes of historic and emerging healthcare information necessary to make optimal medical and economic decisions and outcome predictions for individual patient care plans to improve the cost effectiveness and quality of medical care. Such a system should be prospective, probabilistic-based, outcome predictive, and should utilize emerging information, which is uniquely analyzed, weighted, electronically transformed, and optionally re-analyzed for specified levels of predictive confidence. Accordingly, we have identified a long-felt and unmet need for an assessment of health or economic outcomes that is based on prospective emerging data, processed in real-time, and individualized to each patient.

In a first aspect, provided herein are computer-implemented platforms, systems, products, devices, modules and methods for the real-time, individualized, and probabilistic-based prediction of a health or economic outcome of a patient or healthcare provider comprising the transformation of emerging health or economic data to predict a health or economic outcome of the patient. In some embodiments, provided is a platform. In still further or additional embodiments, provided is a system. In further or additional embodiments, provided is a product. In still further or additional embodiments, provided is a device or module. In yet additional embodiments, provided is a method. In some embodiments, provided is a module that is configured to transform individualized emerging health or economic data that has been acquired in real-time into at least one model set for the prediction of a health or economic outcome. In further or additional embodiments, provided is a module that is configured to determine the sufficiency of the model set by comparing the model set against previously accumulated internal data for sufficiency and if necessary prompting for additional data until a preferred confidence level is achieved. In yet additional embodiments, provided is a module that is configured to analyze the model set using at least one statistical model. In yet additional embodiments, provided is an optional module that is configured to enhance predictive accuracy by comparing an expected result or outcome to an actual result or outcome to train, re-train, or validate at least one statistical model that generates a real-time, individualized, and probabilistic-based output that is a prediction of a health or economic outcome of the patient, the healthcare provider therapy, or the healthcare provider.

In a second aspect, provided herein are computer-implemented platforms, systems, products, devices, modules and methods for the real-time, individualized, and probabilistic-based prediction of a health or economic outcome comprising the step of transforming individualized emerging health or economic data that has been acquired in real-time into at least one model set for the prediction of a health or economic outcome of a patient or healthcare provider therapy. In some embodiments, provided is a platform. In still further or additional embodiments, provided is a system. In further or additional embodiments, provided is a product. In still further or additional embodiments, provided is a device or module. In yet additional embodiments, provided is a method. In a specific embodiment, the emerging health or economic data comprises data derived from one or more of the following: at least one patient; at least one healthcare provider; at least one healthcare expert; and at least one extrinsic, electronic source.

In a third aspect, provided herein are computer-implemented platforms, systems, products, devices, modules and methods for the determination of the sufficiency of a model set that was transformed from emerging health or economic data that was acquired in real-time by comparing the model set against previously accumulated internal data for sufficiency and if necessary prompting for additional data until a preferred confidence level is achieved. In some embodiments, provided is a platform. In still further or additional embodiments, provided is a system. In further or additional embodiments, provided is a product. In still further or addition embodiments, provided is a device or module. In yet additional embodiments, provided is a method. In a specific embodiment, the sufficiency of the model set is determined by comparing the model set to a preferred confidence level from acceptable data.

In a fourth aspect, provided herein are computer-implemented platforms, systems, products, devices, modules and methods using a statistical model to analyze a model set that was transformed from emerging health or economic data that was acquired in real-time and thereby providing the real-time, individualized, and probabilistic-based prediction of a health or economic outcome. In some embodiments, provided is a platform. In still further or additional embodiments, provided is a system. In further or additional embodiments, provided is a product. In still further or addition embodiments, provided is a device or module. In yet additional embodiments, provided is a method. In a specific embodiment, the statistical model is based on at least one of the following: a linear model; a logistic regression; a classification and regression tree; a random forest; a multivariate adaptive regression spline; or a support vector machine. In another embodiment, the statistical modeling further comprises at least one accuracy test and is weighted based on previously accumulated data including, as non-limiting examples, a Bayesian prior; a training and validation data; a cross-validation; a regularization; or a bagging.

In a fifth aspect, provided herein are computer-implemented platforms, systems, products, devices, modules and methods for the enhancement of a predictive accuracy by comparing an expected result or outcome of a patient or healthcare provider to an actual result or outcome of a patient or healthcare provider to train, re-train, or validate at least one statistical model and thereby providing the real-time, individualized, and probabilistic-based prediction of a health or economic outcome. In some embodiments, provided is a platform. In still further or additional embodiments, provided is a system. In further or additional embodiments, provided is a product. In still further or addition embodiments, provided is a device or module. In yet additional embodiments, provided is a method. In some embodiments, the output is a risk score. In further or additional embodiments, the output is a health output which comprises: at least one treatment recommendation; at least one insurance recommendation; at least one opinion on compliance with insurance payer standards; at least one opinion on compliance with medical standards; at least one analysis on economic costs associated with the risk score; at least one analysis on a period of time associated with the risk score; or at least one analysis on quality of care.

In a sixth aspect, provided herein are computer-implemented platforms, systems, products, devices, modules and methods for the real-time, individualized, and probabilistic-based analysis of a health or economic outcome comprising the step of providing an analysis that is based on emerging health or economic data that has been transformed in real-time into at least one model set for analysis of the health or economic outcome of a patient or a healthcare provider therapy. In some embodiments, provided is a platform. In still further or additional embodiments, provided is a system. In further or additional embodiments, provided is a product. In still further or addition embodiments, provided is a device or module. In yet additional embodiments, provided is a method. In a specific embodiment, the analysis provides an output that is a prediction of a health outcome of a patient. In further or additional embodiments, the analysis provides an output that is a positive or negative outcome or assessment of a medical therapy provided by a healthcare provider wherein said healthcare provider is selected from a hospital, an outpatient clinic, an ambulatory care facility, a radiology facility, or a specialty medical group or facility.

### BRIEF DESCRIPTION OF THE DRAWINGS

FIG. 1 shows a non-limiting pictorial illustration of a computer-implemented system for prediction of health or economic outcomes; in this case, a computer-implemented system for prediction of health or economic outcomes that includes a software module for enhancing predictive accuracy 6 by comparing an expected outcome to one or more actual outcomes 4 to train, re-train, or validate at least one statistical model.

FIG. 2 shows a non-limiting pictorial illustration of a software module for acquiring and transforming health data; in this case, a software module for acquiring and transforming emerging health data in real-time including options for minimum accuracy settings 13, stratified expert data validation 14, and diagnostic code input 15.

FIG. 3 shows a non-limiting pictorial illustration of a software module for determining the sufficiency of health data; in this case, a software module for determining the sufficiency of data by comparing the data 16 to previously accumulated internal data 20 and prompting for additional data 17 if necessary to reach a preferred confidence level in a prediction of a health outcome.

FIG. 4 shows a non-limiting pictorial illustration of a software module for analysis of a model data set using at least one statistical model; in this case, software module for analysis of a model data set using one or more of six statistical models 22 individually evaluated by one or more of five accuracy tests 29.

FIG. 5 shows a non-limiting pictorial illustration of a software module for output and implementation of a risk determination valuation; in this case, a software module for output and implementation of a risk determination valuation 35 that includes options for comparison of the valuation to an original opinion 38, stratified expert validation 39, and dispute resolution procedures 40, 41 that allow one or more experts or insurance payers to challenge the valuation. The pictorial illustration also demonstrates non-limiting examples of implementation formats including recommendations 41, 45, opinions 43, 46, and analyses 44, 47, 48.

### DETAILED DESCRIPTION OF THE INVENTION

Provided herein, in various embodiments, are computer-implemented platforms, systems, products, devices and methods for the real-time, individualized, and probabilistic-based prediction of a health or economic outcome of a patient or healthcare provider comprising the transformation of emerging health or economic data to predict a health or economic outcome of the patient.

Also described herein are computer-implemented methods and apparatuses (including platforms, systems, products, and devices) comprising a step of, or module that is configured to comprise, the transformation of individualized emerging health or economic data that has been acquired in real-time into at least one model set for the prediction of a health or economic outcome. In further or additional embodiments, provided herein is a module that is configured to determine the sufficiency of the model set by comparing the model set against previously accumulated internal data for sufficiency and if necessary prompting for additional data until a preferred confidence level is achieved. In some embodiments, including the methods and aforementioned apparatuses (including the computer-implemented platforms, systems, products, and devices described herein), provided is a module that is configured to analyze the model set using at least one statistical model. In yet further or additional embodiments, provided herein is a module that is configured to enhance predictive accuracy by comparing an expected result or outcome to an actual result or outcome to train, re-train, or validate at least one statistical model.

Also provided for herein are products, systems, modules, platforms, devices, and methods for the real-time, individualized, and probabilistic-based analysis of a health or economic outcome comprising the provision of analysis that is based on emerging health or economic data that has been transformed in real-time into at least one model set for analysis of the health or economic outcome of a patient or a healthcare provider therapy. For example, in some embodiments, the analysis provides an output that is a positive or negative assessment, positive or negative outcome, or positive or negative prediction. In some embodiments, the analysis provides an output that is an assessment or prediction of a health outcome of a patient. In further or additional embodiments, the analysis provides an output that is an assessment or prediction of an economic outcome of a patient. In still further or additional embodiments, the analysis provides an output that is an assessment or prediction or an economic outcome of an insurance payer of services received, or proposed to be received, by a patient. In yet additional embodiments, the analysis provides an output that is a positive or negative assessment, outcome, or prediction of a medical procedure performed, or proposed to be performed, by a healthcare provider. In further embodiments, the healthcare provider is, by way of non-limiting examples, one or more treating physicians, physician-assistants, pharmacists, nurses, nurse practitioners, dentists, optometrists, dieticians, audiologists, psychologists, and other health professionals. In some embodiments, the analysis provides an output that is a positive or negative assessment, outcome, or prediction of a medical therapy provided, or proposed to be provided, by a healthcare provider. In further embodiments, the healthcare provider is, by way of non-limiting examples, one or more hospitals, outpatient clinics, ambulatory care facilities, radiology facilities, or specialty medical groups and/or facilities. In specific embodiments, the analysis provides a positive or negative assessment, outcome, or prediction of a health or economic outcome of a drug substance that has been administered, or proposed to be administered, to a patient. In yet additional embodiments, the analysis provides an output of a health or economic outcome of a pharmaceutical company that has supplied or taught a therapeutic method of treatment that has been administered, or proposed to be administered, to a patient.

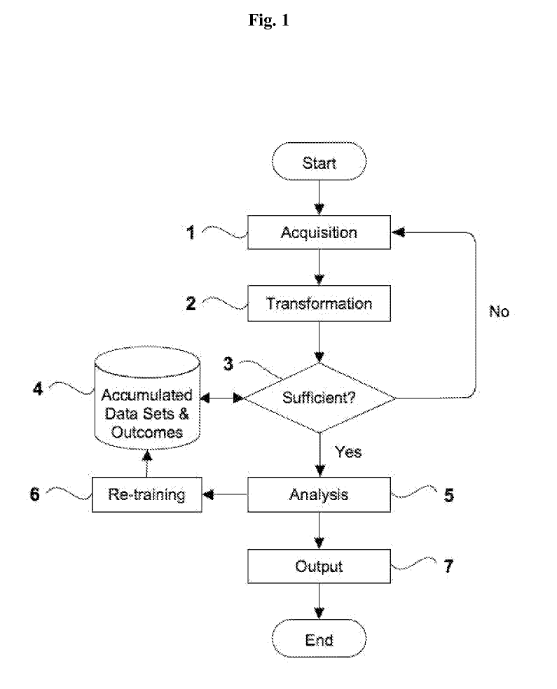

Referring to FIG. 1, shown is a non-limiting pictorial illustration of a computer-implemented system for prediction of health or economic outcomes. In this non-limiting system embodiment, emerging health or economic data is acquired 1. A module 2 is configured to transform the emerging health or economic data into at least one model set. The model set is then an input into at least one statistical model. A module 3 is configured to determine the sufficiency of the model set by comparing the model set against previously accumulated internal data 4 for sufficiency and if necessary prompting for additional data until a preferred confidence level is achieved (not shown). If the data is sufficient, a module 5 then analyzes the model set using at least one statistical model. Optionally, a module 6 is then configured to train and optionally re-train or validate at least one statistical model of the system to enhance predictive accuracy by comparing an expected result or outcome to an actual result or outcome. The system produces an output 7 that is real-time, individualized, and probabilistic-based, and that comprises a prediction of a health or economic outcome of the patient or the healthcare provider therapy. In some embodiments, a database module selects input parameters according to predetermined criteria. For example, in certain embodiments, a module chooses input parameters by experimentation and/or expert opinions.

### Transformation of Emerging Health or Economic Data

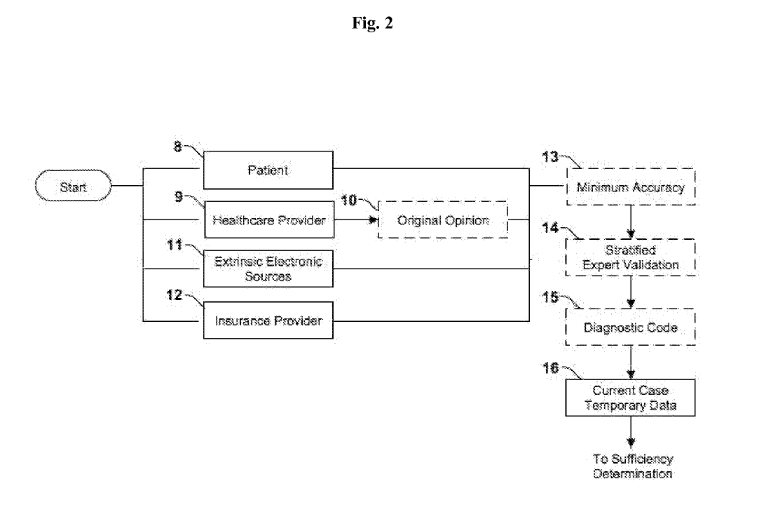

A feature of the subject matter provided herein is the transformation of individualized emerging health or economic data that has been acquired in real-time into at least one model set for the prediction of a health or economic outcome of a patient or healthcare provider therapy. See, e.g., FIG. 2. “Emerging health or economic data,” refers to timely and relatively recent data and information. In some embodiments, the emerging health or economic data is derived from a source that has not been peer reviewed by one or more healthcare or economic professionals. In other embodiments, the emerging health or economic data is derived from a source that has been peer reviewed by one or more healthcare or economic professionals. In some embodiments, the emerging health or economic data is derived from a source that has not been published. In other embodiments, the emerging health or economic data is derived from a source that has been published. In some embodiments, the emerging health or economic data refers to data obtained from sources including, by way of non-limiting examples, third party commercial healthcare payers or providers, pharmaceutical companies, private medical centers, professional healthcare societies or associations, economic or healthcare databases, Medicare bulletins, U.S. Centers for Disease Control and Prevention (CDC) announcements, U.S. Federal Drug Administration (FDA) announcements, other domestic or foreign government communications, and medical conventions wherein new emerging information may have been announced but not yet published in medical journals for peer review. In some embodiments, the emerging health or economic data refers to data obtained from urgent news and/or announcements distributed in public media.

In further or additional embodiments, the emerging health or economic data is derived from the Internet and obtained by an automated web crawler program, a web bot program, or a web robot program. In further or additional embodiments, the emerging health or economic data comprises data derived from one or more of the following: at least one patient; at least one healthcare provider; at least one healthcare expert; or at least one extrinsic, electronic source.

In some embodiments of the systems, platforms, products, devices, modules and methods described herein, the emerging health or economic data comprises data derived from at least one healthcare provider wherein said healthcare provider is selected from treating physicians, physician-assistants, pharmacists, nurses, nurse practitioners, dentists, optometrists, dieticians, audiologists, psychologists, and other health professionals. In specific embodiments, a healthcare provider inputs an original opinion. In still further or additional embodiments, a healthcare provider is selected from a hospital, an outpatient clinic, an ambulatory care facility, a radiology facility, or a specialty medical group or facility.

Also provided herein is a system, platform, product, device, module or method wherein a healthcare expert is selected from non-treating physicians, physician-assistants, pharmacists, nurses, nurse practitioners, dentists, optometrists, dieticians, audiologists, psychologists, and other health professionals. In further or additional embodiments, a healthcare expert is selected from non-treating physicians, physician-assistants, pharmacists, nurses, nurse practitioners, dentists, optometrists, dieticians, audiologists, psychologists, and other health professionals.

In specific embodiments, emerging health or economic data is derived from a drug or therapeutic method of treatment. In further or additional embodiments, emerging health or economic data is derived from a pharmaceutical company. In still further embodiments, data is acquired from said extrinsic, electronic source by utilizing automated web crawler software, web bot software, or web robot software. In yet further or additional embodiments, emerging data is derived from at least one extrinsic, electronic source. In further or additional embodiments, the one or more extrinsic, electronic sources is selected from social media updates, company web sites, RSS news feeds, FDA website bulletins, medical journal websites, Internet-based numeric databases, and other Internet sources. In some embodiments, the extrinsic, electronic source is an EMR system that comprises: at least one database connected to one or more healthcare providers for storing the medical records of the user; or an authorization module, wherein said user controls the data shared between at least one healthcare provider and said database. In further embodiments, an output is shared with the users of the EMR system. In some embodiments, a patient is an individual user or a third party authorized by the user. In still further embodiments, a request to the user is made for an actual outcome.

In some embodiments, emerging health or economic data is combined with non-emerging historical data prior to the transformation into the model set. In some embodiments, the historical data includes input parameters including any appropriate type of data associated with a medical application. For example, in some embodiments, the historical input parameter comprises a medical record from one or more hospitals or healthcare institutions.

For example, in some embodiments, a medical record includes information about parameters related to an individual patient's blood, urine, saliva, and/or other fluid analysis (e.g., gastrointestinal, reproductive, and cerebrospinal fluid analysis). In further or additional embodiments, the medical record data includes data obtained from various medical analysis systems, such as polymerase chain reaction (PCR) analysis systems, genetic marker analysis systems, radioimmunoassay systems, chromatography analysis systems, and/or receptor assay systems, and the like. Data from other analysis systems, such as tissue analysis systems, cytology and tissue typing systems, and/or immunocytochemistry and histopathological analysis are also included in some embodiments. In some embodiments, the medical record data comprises data records using systems including the publicly available models from Harvard School of Public Health, the American Diabetes Association, the American Heart Association, the National Institutes of Health, and the like. In some embodiments, data for a particular individual is obtained for example directly from user inputs, from a database, or from other computer systems maintaining such data. Individual data in some embodiments reflects any health related information about the individual user, such as age, sex, height, exercise level, cholesterol level, blood pressure, diet, particular diseases and treatments, health habits (e.g., smoking, drinking alcohol), and the like.

In some embodiments, data for a particular individual is obtained for example directly from user inputs, from a database, or from other computer systems maintaining such data. Individual data in some embodiments reflects any health related information about the individual user, such as age, sex, height, exercise level, cholesterol level, blood pressure, diet, particular diseases and treatments, health habits (e.g., smoking, drinking alcohol), and the like.

In still further embodiments, medical record data includes clinically measured information of individual patients, such as clinical medical data (e.g., age, sex, height, exercise level, cholesterol level, blood pressure, diet, particular diseases and treatments, health habits, etc.) or other clinical test data such as electroencephalographs (EEG), electrocardiographs (ECG), electromyographs (EMG), electrical impedance tomographs (EIT), nerve conduction test data, electronystagmography (ENG), X-ray images, magnetic resonance (MR) images, computed tomography (CT) images, positron emission tomographs (PET), and/or fluorography, mammography, sonography, infrared, nuclear, and thermoacoustic images, and the like.

In still further or additional embodiments, historical data includes data collected from experiments designed for collecting such data. Alternatively, in some embodiments the data records are generated artificially by other related processes, such as other medical modeling or analysis processes.

Referring to FIG. 2, shown is a non-limiting pictorial illustration of a software module for acquiring and transforming health data in real-time. Four courses of emerging data are shown, including emerging data from the patient 8, emerging data from a healthcare provider 9 (including optionally the input of an original opinion from a healthcare professional 10), emerging data from an extrinsic, electronic source 11, and emerging data from an insurance provider 12. The non-limiting software module portrayed includes options for minimum accuracy settings 13, stratified expert data validation 14, and diagnostic code input 15. In some embodiments, the collection of emerging data from various sources, optionally validated by one or more experts and optionally supplemented by an original opinion and/or diagnostic code, comprises the current case temporary data 16.

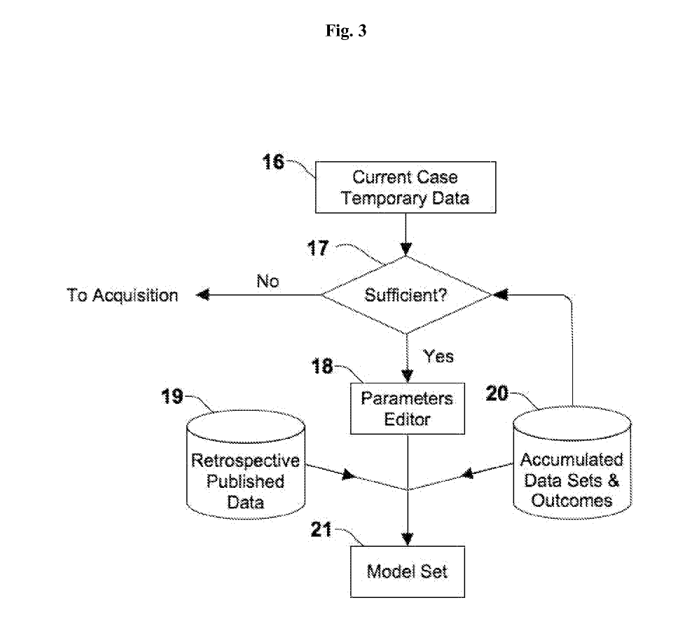

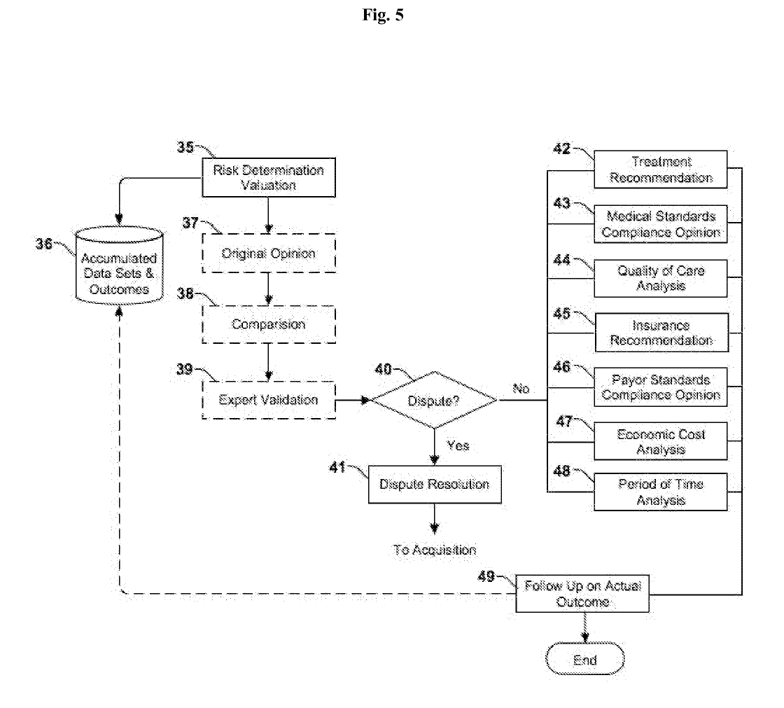

In some embodiments, a user optionally inputs one or more diagnostic codes 15 related to a case. In additional embodiments, the software module for acquiring and transforming health data generates one or more diagnostic codes related to a case. In further embodiments, one or more diagnostic codes are a source of emerging heath data. See, e.g., FIG. 2. In still further embodiments, one or more diagnostic codes are used for billing support. In additional embodiments, one or more diagnostic codes are used in determining sufficiency of a model set. See, e.g., FIG. 3. In additional embodiments, one or more diagnostic codes are used to train, re-train, or validate at least one statistical model. See, e.g., FIG. 5.

In some embodiments, the module calculates or determines certain medical risks based on relationships between certain input variables (including, as one example, from sources 8, 9, 10, 11, and/or 12) to produce a model set for a particular medical risk, such as diabetes, cardiovascular disease (CVD), infection, death, etc. In further or additional embodiments, a model set is based on a particular medical theory or a particular data collection method.

### Sufficiency of the Model Set

Another feature of the subject matter provided herein is the determination of the sufficiency of a model set that was transformed from emerging health or economic data that was acquired in real-time by comparing the model set against previously accumulated internal data for sufficiency and if necessary prompting for additional data until a preferred confidence level is achieved. See, e.g., FIG. 3.

Provided herein are systems, platforms, products, devices, modules and methods comprising the determination of the sufficiency of a model set that was transformed from emerging health or economic data that was acquired in real-time by comparing the model set against previously accumulated internal data for sufficiency and if necessary prompting for additional data until a preferred confidence level is achieved. For example, in some embodiments, a sufficiency of a model set is determined by comparing the model set to a preferred confidence level from acceptable data.

In some embodiments, the preferred confidence level is determined using an individual expert knowledge database including internally created databases and data obtained from external sources. When multiple expert bases are used, medical risks or risk stratifications made by the multiple expert knowledge bases may be different from, inconsistent with, or even conflicting with each other. For example, a same person with a set of characteristics (e.g., a set of particular values of certain variables) may have different stratifications under different expert knowledge bases. It may then be difficult to choose a particular expert knowledge base as a more correct model or to reconcile different expert knowledge bases.

Referring now to FIG. 3, shown is a non-limiting pictorial illustration of a software module for determining the sufficiency of health or economic data. Shown is a software module for determining the sufficiency data 16 to create a model set 21. A sufficiency determination 17 of acquired data (e.g., current case temporary data 16) is performed by comparing the acquired data 16 to retrospective published data 19 and previously accumulated data sets including predicted and actual outcomes 20. The module prompts for additional data 17 (optionally using a parameters editor to determine the data used in the sufficiency determination) if necessary to reach a preferred confidence level in the prediction of an economic or health outcome of a patient. If no additional data is needed to reach a preferred confidence level, then no further prompting is required and the model set 21 is established.

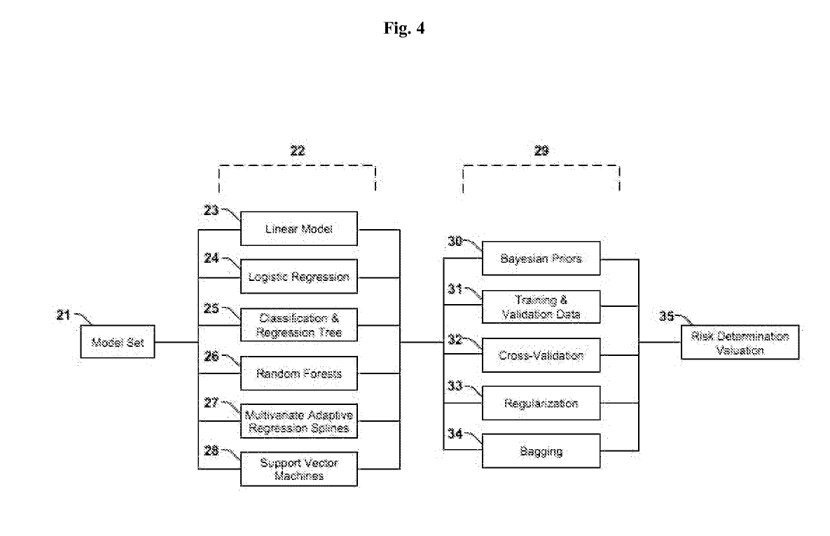

In some embodiments, a sufficiency determination is made by comparing current case temporary data to previously accumulated data sets including predicted and actual outcomes. See, e.g., FIG. 3. In other embodiments, a sufficiency determination is made by subjecting current case temporary data to one or more statistical models, the output of which may be further subjected to one or more accuracy tests. See, e.g., FIG. 4. In further embodiments, a sufficiency determination is made by methods comprising both comparison to accumulated data and statistical modeling. In some embodiments, one or more sufficiency determinations weight individual data according to potential contribution to the overall prediction of one or more health or economic outcomes. In further embodiments, a software module for determining the sufficiency of health or economic data prompts a user for additional data based on one or more particular data's potential contribution to the overall prediction of one or more health or economic outcomes.

In some embodiments, a user optionally inputs one or more diagnostic codes related to a case and/or a software module for acquiring and transforming health data generates one or more diagnostic codes related to a case. In further embodiments, the diagnostic codes are standardized and internationally recognized, thus creating efficiency in the system. In further embodiments, a software module for determining the sufficiency of health or economic data prompts for additional data, based in part or in whole, on one or more assigned diagnostic codes related to a case. In still further embodiments, the use of diagnostic codes minimizes the data required by prompting only for data that will be most significant in the sufficiency of the model set.

### Enhancing Predictive Accuracy Using Statistical Modeling

Yet another feature of the subject matter provided herein is the use of a statistical model to analyze a model set that was transformed from emerging health or economic data that was acquired in real-time. See, e.g., FIG. 4. In some embodiments, provided herein are systems, platforms, products, devices, modules and methods comprising a computer usable medium having a computer readable program code embodied therein that is adapted to be executed to implement a method for the real-time, individualized, and probabilistic-based prediction of a health or economic outcome comprising the step of using a statistical model to analyze a model set that was transformed from emerging health or economic data that was acquired in real-time and thereby providing the real-time, individualized, and probabilistic-based prediction of a health or economic outcome. For example, in some embodiments, the statistical model is any appropriate type of mathematical or physical model indicating interrelationships between input parameters and output parameters. In some embodiments, the statistical model is based on at least one of the following: a linear model; a logistic regression; a classification and regression tree; a random forest; a multivariate adaptive regression spline; or a support vector machine. In some embodiments, the statistical model is based on at least two of the following: a linear model; a logistic regression; a classification and regression tree; a random forest; a multivariate adaptive regression spline; or a support vector machine. In further or additional embodiments, the statistical model is based on at least three of the following: a linear model; a logistic regression; a classification and regression tree; a random forest; a multivariate adaptive regression spline; or a support vector machine. In some embodiments, the statistical model is based on at least four of the following: a linear model; a logistic regression; a classification and regression tree; a random forest; a multivariate adaptive regression spline; or a support vector machine. In some embodiments, the statistical model is based on all of the following: a linear model; a logistic regression; a classification and regression tree; a random forest; a multivariate adaptive regression spline; or a support vector machine. In still further embodiments, the statistical model is a mathematical model. In a specific embodiment, the statistical model is a fuzzy logic model.

In some embodiments of the subject matter provided herein, provided is a system, platform, product, device, module and method comprising a computer usable medium having a computer readable program code embodied therein that is adapted to be executed to implement a method for the real-time, individualized, and probabilistic-based prediction of a health or economic outcome comprising the step of using a statistical model to analyze a model set that was transformed from emerging health or economic data that was acquired in real-time and thereby providing the real-time, individualized, and probabilistic-based prediction of a health or economic outcome further comprising the independent and simultaneous analyzing of the model set using at least two of the aforementioned statistical models. In some embodiments, at least one statistical model is subjected to at least one accuracy test and is weighted based on previously accumulated data. In further or additional embodiments, a predictive accuracy is further improved by comparing an actual outcome against a predicted outcome. In yet additional embodiments, the accuracy is determined using at least one of the following: a Bayesian prior; a training and validation data; a cross-validation; a regularization; or a bagging. In some embodiments, the accuracy test comprises at least two of the following a Bayesian prior; a training and validation data; a cross-validation; a regularization; or a bagging. In some embodiments, the accuracy test comprises at least three of the following: a Bayesian prior; a training and validation data; a cross-validation; a regularization; or a bagging. In yet additional embodiments, the accuracy test comprises at least four of the following: a Bayesian prior; a training and validation data; a cross-validation; a regularization; or a bagging. In some embodiments, the accuracy test comprises at least five of the following: a Bayesian prior; a training and validation data; a cross-validation; a regularization; or a bagging. In still further or additional embodiments, the accuracy test comprises all of the following: a Bayesian prior; a training and validation data; a cross-validation; a regularization; or a bagging.

Referring to FIG. 4, shown is a non-limiting pictorial illustration of a software module for analysis of a model data set using one or more of six statistical models 22 and one or more of five accuracy tests 29. Shown are six exemplary statistical models 22 including: a linear model 23; a logistic regression 24; a classification and regression tree 25; a random forest 26; a multivariate adaptive regression spline 27; and a support vector machine 28. The exemplary accuracy tests 29 include: a Bayesian prior 30; a training and validation data 31; a cross-validation 32; a regularization 33; and a bagging 34.

The term “meta-analysis” as considered herein, refers to a method of statistical examination that combines the results of a plurality of retrospective, controlled studies that are published in medical literature and address shared research hypotheses. One non-limiting advantage of the systems, platforms, products, devices, modules and methods disclosed herein is using a statistical model to analyze a model set that was transformed from emerging health or economic data that was acquired in real-time from emerging health and/or economic data and is individualized to one or more particular individuals. Another non-limiting advantage of the subject matter disclosed herein is one or more live experts optionally validating, weighting, and potentially disputing data, statistical models, accuracy tests of statistical model output, and predictions of health or economic outcomes.

The subject matter disclosed herein, in non-limiting embodiments, uses one or more non-meta-analytical models to analyze a model set. In some embodiments, the present invention comprises a module configured to analyze a model set using at least one statistical model, including one or more non-meta-analyses and does not include meta-analysis. In other embodiments, the present invention comprises a module configured to analyze a model set using at least one statistical model, including one or more meta-analyses. In further embodiments, the present invention comprises a module configured to analyze a model set using at least one statistical model, including one or more meta-analyses and one or more non-meta-analyses.

### Output Prediction of a Health or Economic Outcome

An additional feature of the subject matter provided herein is the enhancement of a predictive accuracy by comparing an expected result or outcome of a patient or healthcare provider to an actual result or outcome of a patient or healthcare provider to train, re-train, or validate at least one statistical model. See, e.g., FIG. 5. Accordingly, in some embodiments, provided herein are systems, platforms, products, devices, modules and methods comprising a computer usable medium having a computer readable program code embodied therein that is adapted to be executed to implement a method for the real-time, individualized, and probabilistic-based prediction of a health or economic outcome comprising the enhancement of a predictive accuracy by comparing an expected result or outcome of a patient or healthcare provider to an actual result or outcome of a patient or healthcare provider to train, re-train, or validate at least one statistical model and thereby providing the real-time, individualized, and probabilistic-based prediction of a health or economic outcome. In some embodiments, the output is a risk score. In further or additional embodiments, the output is a health output which comprises: at least one treatment recommendation; at least one insurance recommendation; at least one opinion on compliance with insurance payer standards; at least one opinion on compliance with medical standards; at least one analysis on economic costs associated with the risk score; at least one analysis on a period of time associated with the risk score; or at least one analysis on quality of care. In some embodiments, the output further comprises an economic output. In certain embodiments, provided is a dispute resolution process. In some embodiments, the dispute resolution process allows one or more live experts, involved in validation, to challenge a health or economic output. In further embodiments, one or more challenges by live experts is used to train, re-train, or validate at least one statistical model. In some embodiments, the dispute resolution process allows one or more insurance payers to challenge a health or economic output. In certain embodiments, an output further comprises a value score. In still further embodiments, provided is an output wherein a live expert supplements the output by generating an expert recommendation or opinion. In still further or additional embodiments, an output parameter is provided that corresponds to certain medical risks or any other types of output parameters used by the particular medical application.

In a specific embodiment, provided is an output that further comprises an economic output. In some embodiments, provided is a dispute resolution process with an insurance payer. In certain embodiments, provided is an output that is a value score. In still further embodiments, provided is an output, wherein a live expert supplements the output by generating an expert recommendation or opinion.

In further embodiments, after a module is trained and validated, a module is optimized to define a desired input space of input parameters and/or a desired distribution of output parameters. The validated or optimized module, in further or additional embodiments, produces corresponding values of output parameters when provided with a set of values of input parameters. For example, in some embodiments, a module is used to produce individual risk prediction based on individual data. Further, in some embodiments, a module is used to find group risk prediction based on group data.

In some embodiments, once trained or validated, an individual user utilizes the system, platform, product, device, module and method described herein to predict one or more healthcare or economic risks based upon individual medical data. An individual perspective process is provided of healthcare or economic risks to the individual user or subject third party.

Referring to FIG. 5, shown is a non-limiting pictorial illustration of a software module for output and implementation of a risk determination valuation. Provided in this non-limiting example is a module for output and implementation of a risk determination valuation 35 that includes options for an original opinion 37, comparison of the valuation to an original opinion 38, stratified expert validation 39, and dispute resolution procedures 40, 41 that allow one or more healthcare experts or insurance payers to challenge the valuation. The pictorial illustration also demonstrates non-limiting examples of implementation formats including recommendations 42 (treatment recommendations), 45 (insurance recommendation), opinions 43 (medical standards compliance), 46 (payer standards compliance), and analyses 44 (quality of care), 47 (economic cost), 48 (period of time), and the interrelationship between follow-up on actual outcomes 49 and its comparison with previously accumulated data sets and outcomes 36.

### Live Expert Interaction

Another feature of the subject matter described herein is the interaction of one or more live experts to validate a model set for the prediction of a health or economic outcome of a patient or healthcare provider therapy. In some embodiments, one or more live experts validate or weight one or more model sets. In some embodiments, one or more live experts validate or weight current case data. In specific embodiments, one or more live experts validate one or more risk scores. In some embodiments, one or more live experts validate or weight one or more statistical models. In some embodiments, one or more live experts validate or weight one or more accuracy tests of statistical model output. In some embodiments, one or more live experts validate or weight one or more predictions of health or economic outcomes. In some embodiments, one or more live experts optionally challenges an aspect of the system they are involved in validating through a dispute resolution process. In some embodiments, one or more live experts are healthcare experts. In some embodiments, one or more live experts are economic, business, healthcare facility administration, or insurance experts.

In some embodiments, multiple live experts are simultaneously and electronically linked to facilitate communication and collaboration. In further embodiments, multiple live experts are simultaneously and electronically linked by technologies including, by way of non-limiting examples, blog, message board, instant messaging, telephone conferencing, video conferencing, web conferencing, Internet-based real-time collaboration, and intranet-based real-time collaboration.

In further or additional embodiments, provided is a module for identifying potential human data entry errors by recognizing expected minimum and maximum values, normal range, and other abnormal flags. In some embodiments, one or more live experts supplement and validate the identification of data errors.

### Computer-Implementation

Disclosed herein are computer-implemented products, systems, modules, platforms, devices, and methods for the real-time, individualized, and probabilistic-based analysis of a health or economic outcome of a patient or healthcare provider therapy. In some embodiments, the computer-implemented products, systems, modules, platforms, devices, and methods are intranet-based. In some embodiments, the computer-implemented products, systems, modules, platforms, devices, and methods are Internet-based. In further or additional embodiments, the computer-implemented products, systems, modules, platforms, devices, and methods are World Wide Web-based. In still further embodiments, the computer-implemented products, systems, modules, platforms, devices, and methods are based on cloud computing. In other embodiments, the computer-implemented products, systems, modules, platforms, devices, and methods are based on data storage devices including, by way of non-limiting examples, CD-ROMs, DVDs, flash memory devices, solid state memory, magnetic disk drives, magnetic tape drives, optical disk drives, and the like.

In some embodiments, a computer readable module or software module includes computer a usable medium or media encoded with computer readable program code. In further embodiments, a computer usable medium is a tangible component of a computer system. In still further embodiments, a computer usable medium is optionally removable from a computer system. In some embodiments, a computer usable medium includes, by way of non-limiting examples, CD-ROMs, DVDs, flash memory devices, solid state memory, magnetic disk drives, magnetic tape drives, optical disk drives, cloud computing systems and services, and the like.

The computer program includes a sequence of instructions, executable in the digital processing device's CPU, written to perform a specified task. Those of skill in the art will recognize that the computer program may be written in various versions of various languages. The computer program may be written in one or more markup languages, style languages, client-side scripting languages, server-side coding languages, or combinations thereof. In some embodiments, the computer program is written to some extent in a markup language such as Hypertext Markup Language (HTML), Extensible Hypertext Markup Language (XHTML), or eXtensible Markup Language (XML). In some embodiments, the computer program is written to some extent in a style language such as Cascading Style Sheets (CSS). In some embodiments, the computer program is written to some extent in a client-side scripting language such as Asynchronous Javascript and XML (AJAX), Flash®, Actionscript, Javascript, or Silverlight®. In some embodiments, the computer program is written to some extent in a server-side coding language such as Active Server Pages (ASP), ColdFusion®, Common Gateway Interface (CGI), Perl, Java™, Hypertext Preprocessor (PHP), Python™, Ruby, Structured Query Language (SQL), mySQL™, Oracle®, or .NET.

The products, systems, modules, platforms, devices, and methods described herein comprise software, server, and database modules. In view of the disclosure provided herein, these modules are created by techniques known to those of skill in the art using machines, software, and languages known to the art. In some embodiments, the modules are in a single computer program. In other embodiments, the modules are in more than one computer program. In some embodiments, the modules are hosted on one machine. In other embodiments, the modules are hosted on more than one machine. In some embodiments, the modules are hosted on one or more machines in one location. In other embodiments, the modules are hosted on one or more machines in more than one location. Further described herein is the formatting of data. In some embodiments, the data files described herein are formatted in a data serialization format known to those in the art including, by way of non-limiting examples, tab-separated values, comma-separated values, character-separated values, delimiter-separated values, XML, JSON, BSON, and YAML.

The products, systems, modules, platforms, devices, and methods described herein comprise a digital processing device. The digital processing device includes one or more hardware central processing units (CPU) that carry out the device's functions. The digital processing device further comprises an operating system configured to perform executable instructions, a memory device, a display, an input device, and optionally a sound output device. In some embodiments, the digital processing device is connected to the Internet such that it accesses the World Wide Web. In other embodiments, the digital processing device is connected to an intranet. In other embodiments, the digital processing device is connected to a data storage device.

In accordance with this description herein, suitable digital processing devices include, by way of non-limiting examples, desktop computers, laptop computers, notebook computers, net book computers, set top computers, handheld computers, Internet appliances, mobile smart phones, tablet computers, and video game consoles. Those of skill in the art will recognize that many Internet connected mobile phones are suitable for use in the system described herein. Suitable tablet computers include those with booklet, slate, and convertible configurations, known to those of skill in the art. In some embodiments, provided is a system that further comprises a module or step adapted for display of information on mobile devices.

The digital processing device includes an operating system configured to perform executable instructions. The operating system is, for example, software, including programs and data, which manages the device's hardware and provides services for execution of applications. Those of skill in the art will recognize that suitable personal computer operating systems include, by way of non-limiting examples, Microsoft® Windows®, Apple® Mac OS X®, UNIX®, and UNIX-like operating systems such as GNU/Linux®. In some embodiments, the operating system is provided by cloud computing. Those of skill in the art will also recognize that suitable mobile smart phone operating systems include, by way of non-limiting examples, Nokia® Symbian® OS, Apple® iOS®, Research In Motion® BlackBerry OS®, Google® Android®, Microsoft® Windows Phone® OS, Microsoft® Windows Mobile® OS, Linux®, and Palm® WebOS®.

The digital processing device includes a memory device. The memory is one or more physical apparatus used to store data or programs on a temporary or permanent basis. In some embodiments, the memory is volatile and requires power to maintain stored information. In some embodiments, the memory is non-volatile and retains stored information when the digital processing device is not powered.

The digital processing device includes a display to send visual information to a user. In some embodiments, the display is a cathode ray tube (CRT). In some embodiments, the display is a liquid crystal display (LCD). In further embodiments, the display is a thin film transistor liquid crystal display (TFT-LCD). In some embodiments, the display is a plasma display. In other embodiments, the display is a video projector. In still further embodiments, the display is a combination of devices such as those disclosed herein.

The digital processing device includes an input device to receive information from a user. In some embodiments, the input device is a keyboard. In some embodiments, the input device is a pointing device including, by way of non-limiting examples, a mouse, trackball, track pad, joystick, game controller, or stylus. In some embodiments, the input device is a touch screen or a multi-touch screen. In other embodiments, the input device is a microphone to capture voice or other sound input. In other embodiments, the input device is a video camera to capture motion or visual input. In still further embodiments, the input device is a combination of devices such as those disclosed herein.

The digital processing device optionally includes a sound output device to send auditory information to a user. In some embodiments, the sound output device is a pair of headphones, earphones, or ear buds. In some embodiments, the sound output device is an electro-acoustic transducer or loudspeaker. In further embodiments, the sound output device is a flat panel loudspeaker, a ribbon magnetic loudspeaker, or a bending wave loudspeaker. In other embodiments, the sound output device is a piezoelectric speaker. In still further embodiments, the sound output device is a combination of devices such as those disclosed herein.

What is claimed is:

1. A computer-implemented system for the real-time, individualized, and probabilistic-based prediction of a health or economic outcome of a patient or healthcare provider therapy comprising:
a. a digital processing device;
b. a module executed by said processing device and configured to transform individualized emerging health or economic data that has been acquired in real-time into at least one model set for the prediction of a health or economic outcome;
c. a module executed by said processing device and configured to determine the sufficiency of the model set by comparing the model set against previously accumulated internal data for sufficiency and if necessary prompting for additional data until a preferred confidence level is achieved;
d. a module executed by said processing device and configured to analyze the model set using at least one statistical model;
e. optionally, a module executed by said processing device and configured to enhance predictive accuracy by comparing an expected result or outcome to an actual result or outcome to train, re-train, or validate at least one statistical model;
and thereby generating a real-time, individualized, and probabilistic-based output that is a prediction of a health or economic outcome of the patient or the healthcare provider therapy.

2. A computer readable module comprising a computer usable medium having a computer readable program code embodied therein that is adapted to be executed to implement a method for the real-time, individualized, and probabilistic-based prediction of a health or economic outcome comprising the step of transforming individualized emerging health or economic data that has been acquired in real-time into at least one model set for the prediction of a health or economic outcome of a patient, healthcare provider therapy, or payer.

3. The system of claim 2, wherein the emerging health or economic data is combined with historical data prior to transformation into said model set.

4. The system or module of claim 3, wherein the emerging health or economic data comprises data derived from one or more of the following:
a. at least one patient;
b. at least one healthcare provider;
c. at least one healthcare expert;
d. at least one extrinsic, electronic source; and
e. at least one healthcare payer.

5. The system or module of claim 4, wherein data is acquired from said extrinsic, electronic source by utilizing a web crawler, web bot, or web robot.

6. The system or module of claim 4, wherein one or more extrinsic, electronic sources is selected from social media updates, company web sites, RSS news feeds, FDA bulletins, medical journal websites, professional healthcare society or association web sites, Medicare communications, CDC websites, federal drug agency websites, domestic or foreign government websites, numeric databases, and other Internet sources.

7. The system or module of claim 4, wherein said extrinsic, electronic source is an electronic medical record system that comprises:
a. at least one database connected to one or more healthcare providers for storing the medical records of the user; or
b. an authorization module, wherein said user controls the data shared between at least one healthcare provider and said database.

8. The system or module of claim 7, wherein the output of the system or module is shared with the users of the electronic medical record system.

9. The system of claim 1, wherein said patient is an individual user or a third party authorized by the user.

10. The system of claim 1, wherein the system or module requests the user for an actual outcome.

11. A computer readable module comprising a computer usable medium having a computer readable program code embodied therein that is adapted to be executed to implement a method for the real-time, individualized, and probabilistic-based prediction of a health or economic outcome comprising the step of determining the sufficiency of a model set that was transformed from emerging health or economic data that was acquired in real-time by comparing the model set against previously accumulated internal data for sufficiency, and if necessary, prompting for additional data until a preferred confidence level is achieved.

12. The module of claim 11, wherein the sufficiency of said model set is determined by comparing the model set to a preferred confidence level from acceptable data.

13. The system of claim 1, wherein said statistical model is based on at least one of the following:
a. a linear model;
b. a logistic regression;
c. a classification and regression tree;
d. a random forest;
e. a multivariate adaptive regression spline; and
f. a support vector machine.

14. The system of claim 1, wherein said statistical model is based on at least two of the following:
a. a linear model;
b. a logistic regression;
c. a classification and regression tree;
d. a random forest;
e. a multivariate adaptive regression spline; and
f. a support vector machine.

15. The system or module of claim 3, wherein a predictive accuracy is further improved by comparing an actual outcome against a predicted outcome.

16. The system or module of claim 3, wherein an accuracy is determined using at least one of the following:
a. a Bayesian prior;
b. a training and validation data;
c. a cross-validation;
d. a regularization; and
e. a bagging.

17. The system of claim 1, wherein, said output is a health output which comprises at least one of:
a. a treatment recommendation;
b. an insurance recommendation;
c. an opinion on compliance with insurance payer standards;
d. an opinion on compliance with medical standards;
e. an analysis on economic costs associated with the risk score;
f. an analysis on a period of time associated with the risk score; or
g. an analysis on quality of care.

18. A computer implemented method comprising a computer usable medium having a computer readable program code embodied therein that is adapted to be executed to implement a method for the real-time, individualized, and probabilistic-based analysis of a health or economic outcome comprising the step of providing an analysis that is based on emerging health or economic data that has been transformed in real-time into at least one model set for analysis of the health or economic outcome of a patient, healthcare provider therapy, or payer.

19. The system or module of claim 3, wherein one or more live experts validates an overall model set, wherein said one or more live experts are optionally, simultaneously and electronically linked.

20. The system or module of claim 3, wherein one or more live experts validates a risk score resulting in a weighted recommendation, wherein said one or more live experts are optionally, simultaneously and electronically linked.
